(19) United States
(12) Patent Application Publication
(10) Pub. No.: US 2023/0014983 A1
(43) Pub. Date: Jan. 19, 2023

(54) FUEL RAIL COUPLING ARRANGEMENT

(71) Applicant: Caterpillar Inc., Peoria, IL (US)

(72) Inventors: Michael T. McKINLEY, Washington, IL (US); Quinton M. BURCAR, Peoria, IL (US); Brenton W. BUSH, Dunlap, IL (US); Grant M. KLOBUCHAR, Peoria, IL (US)

(73) Assignee: Caterpillar Inc., Peoria, IL (US)

(21) Appl. No.: 17/379,627

(22) Filed: Jul. 19, 2021

(51) Int. Cl. F02M 55/02; F02M 63/02; F02M 55/00

(52) U.S. Cl. CPC F02M 55/025; F02M 63/0225; F02M 55/005; F02M 2200/857

(57) ABSTRACT

In one aspect, a system for coupling a fuel rail of a common rail fuel system to an internal combustion engine may include an engine wall having a plurality of openings. The fuel rail may have a main pipe portion located outside the engine wall, and a plurality of outlet pipes monolithically formed with the main pipe portion, each of the plurality of outlet pipes extending into a corresponding one of the plurality of openings of the engine wall. The system may further include a seal located in sealing engagement with each of the plurality of openings and a corresponding outlet pipe.

### TECHNICAL FIELD

The present disclosure relates generally to internal combustion engines, and more particularly to common rail fuel systems for such engines.

### BACKGROUND

Common rail fuel injection systems, commonly used in diesel engines, deliver high pressure fuel to combustion chambers where the fuel may be combusted to create mechanical power. Such systems may include a high pressure fuel pump delivering fuel to a fuel rail or fuel plenum. The fuel rail supplies high pressure fuel to each fuel injector through a plurality of conduits extending between the fuel rail and the fuel injectors. When the fuel injectors are actuated, high pressure fuel is delivered from the fuel rail, through the fuel injector, and injected into a corresponding combustion chamber. Such common rail fuel systems may be coupled to the engine and include various pipes, tubes, quills, or conduits forming the fuel connection between the fuel rail and the fuel injector. In some instances such fuel connections may allow for detrimental engine fluids, such as fuel or oil vapors to be release via the various connection points or joints in common rail fuel systems and associated engine housings.

U.S. Pat. No. 6,237,569 B1 (“the '569 patent) discloses a common rail fuel system where the common rail is coupled outside of the crankcase of the engine and includes fuel connections extending through portions of the cylinder head to the fuel injectors. The fuel rail of the '569 patent is encapsulated in liquid-tight chamber to thereby form a leak chamber.

The common rail fuel system of this disclosure may solve one or more of the problems set forth above and/or other problems in the art. The scope of the current disclosure, however, is defined by the attached claims, and not by the ability to solve any specific problem.

### SUMMARY

In one aspect, a system for coupling a fuel rail of a common rail fuel system to an internal combustion engine may include an engine wall having a plurality of openings. The fuel rail may have a main pipe portion located outside the engine wall, and a plurality of outlet pipes monolithically formed with the main pipe portion, each of the plurality of outlet pipes extending into a corresponding one of the plurality of openings of the engine wall. The system may further include a seal located in sealing engagement with each of the plurality of openings and a corresponding outlet pipe.

In another aspect, a system for coupling a fuel rail of a common rail fuel system to an internal combustion engine may include an engine wall having a plurality of openings. The fuel rail may include a main pipe portion located outside the engine wall and extending parallel to the engine wall and a plurality of outlet pipes monolithically formed with the main pipe portion. Each of the plurality of outlet pipes may extend into a corresponding one of the plurality of openings of the engine wall. The system may further include a seal located in sealing engagement with each of the plurality of openings and a corresponding outlet pipe. The system may also include a plurality of fasteners fixedly coupling the fuel rail to the engine wall, each fastener of the plurality of fasteners extending into a corresponding securement opening in the engine wall.

In another aspect, a system for coupling a fuel rail of a common rail fuel system to an internal combustion engine may include an engine wall having a plurality of openings. The fuel rail may include a main pipe portion located outside the engine wall and extending parallel to the engine wall and a plurality of outlet pipes monolithically formed with the main pipe portion. Each of the plurality of outlet pipes may extend into, through, and beyond a corresponding one of the plurality of openings of the engine wall. The system may also include a seal located in sealing engagement with each of the plurality of openings and a corresponding outlet pipe. The system may further include a plurality of fasteners fixedly coupling the fuel rail to the engine wall, each fastener of the plurality of fasteners extending into a corresponding securement opening in the engine wall.

### BRIEF DESCRIPTION OF THE DRAWINGS

FIG. 1 shows a schematic perspective view of an engine including a common rail fuel system in accordance with the present disclosure;

FIG. 2 shows a top view of a valve cover and fuel rail of the engine of FIG. 1;

FIG. 3 shows a perspective view of a coupling of the fuel rail to the engine valve cover of FIGS. 1 and 2.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” substantially,” “generally,” and “approximately” are used to indicate a possible variation of ±10% in the stated value.

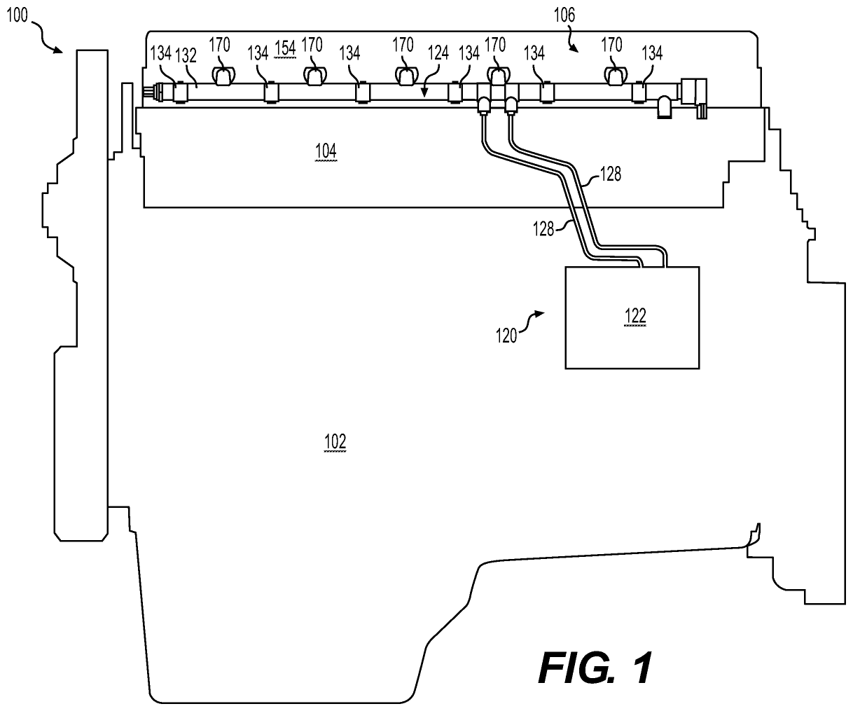

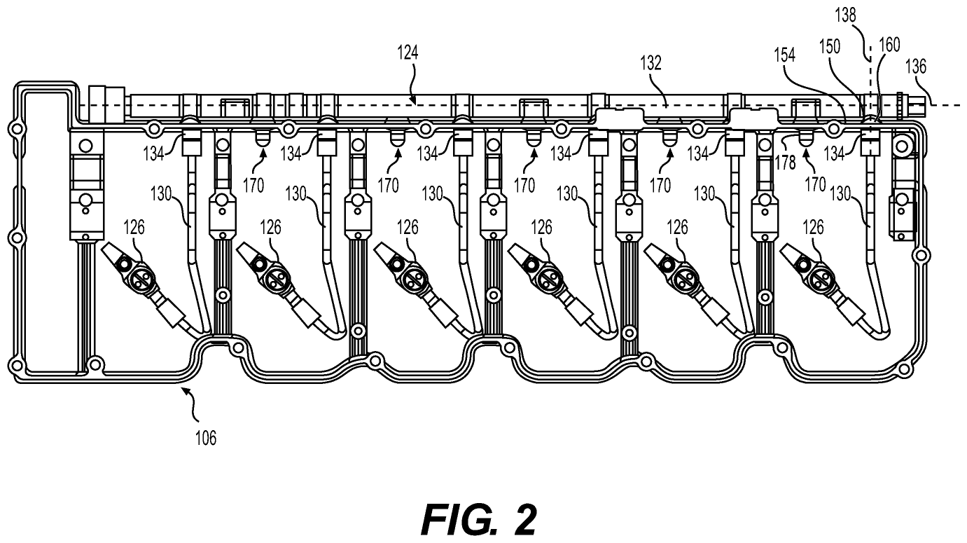

FIG. 1 shows a schematic perspective view an exemplary internal combustion engine 100 according to the present disclosure. While the engine 100 will be discussed below as a diesel fuel engine, it is understood that the engine 100 could run on a different fuel than diesel fuel, and could be a duel-fuel type engine. Engine 100 may include, among other things, an engine block 102 forming a plurality of combustion chambers and housing a crankshaft and pistons (not shown), one or more cylinder heads 104, and one or more valve covers 106, etc. As used herein, valve cover 106, also known as a valve box, forms a housing over cylinder heads 104. As shown in FIGS. 1 and 2, engine 100 may also include a common rail fuel system 120 including, among other things, a high pressure fuel pump 122, a fuel rail 124, and a plurality of fuel injectors 126. The common rail fuel system 120 may also include a plurality of pump-rail fuel lines 128 extending between the pump 122 and fuel rail 124, and a plurality of rail-injector fuel lines 130 extending between the fuel rail 124 and the fuel injectors 126.

The fuel rail 124 may be a single, monolithic tube or pipe structure that includes a longitudinal main pipe portion 132 and a plurality of outlet pipes 134. The main pipe portion 132 of fuel rail 124 extends generally parallel with the length of the engine 100, and parallel to a generally planar portion of a wall 154 of valve cover 106. As best shown in FIG. 2, main pipe portion of fuel rail 124 is generally straight with a longitudinal axis 136. The plurality of outlet pipes 134 (that are formed monolithically with the main pipe portion 132) extend generally perpendicular to the main pipe portion 132, and include a longitudinal axis 138 (only one labeled in FIG. 2). As used herein a “monolithic” structure is a structure that does not allow for disassembly of the relevant parts. For example a monolithic structure may be a structure that is cast, milled, forged, molded, extruded, etc. as a single structure or part, or may be different structures or parts coupled together in a manner that does not allowing for disconnection, such as coupled via welding, brazing, soldering, adhesive bonding, etc. The number of outlet pipes 134 may correspond to the number of fuel injectors, such as the six shown in FIG. 2.

Referring still to FIGS. 1 and 2, the main pipe portion 132 of fuel rail 124 is coupled to an outside, generally planar surface portion of valve cover 106 such that outlet pipes 134 extend through openings 150 in valve cover 106. As shown in FIG. 2, outlet pipes 134 may extend into and completely through and beyond the wall 154 of valve cover 106 and terminate within the interior space of valve cover 106. The rail-injector fuel lines 130 are coupled to the distal end of the outlet pipes 134 in any appropriate manner and extend to the fuel injectors 126. A seal 160 extends between the openings 150 of the valve cover 106 and outlet pipes 134 to restrict escape of engine fluids through valve cover openings 150.

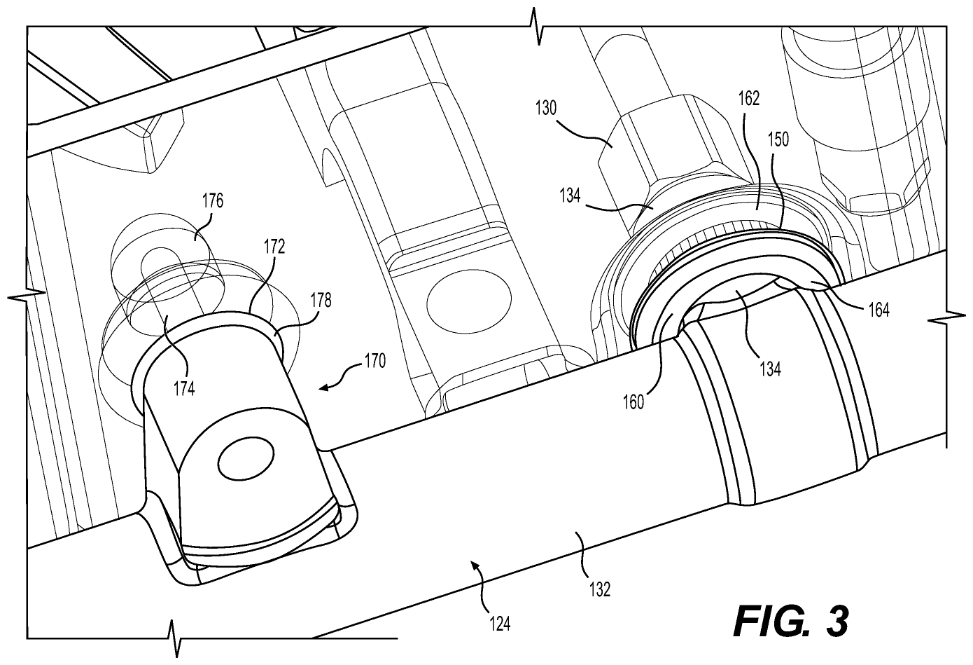

FIG. 3 provides an enlarged view of outlet pipes 134 extending through valve cover openings 150 (with the valve cover wall 154 being removed). As shown in figure, seal 160 may sealingly encircle outlet pipes 134, sealingly engage valve cover opening 150, and may extend both internally and externally of valve cover 106. For example, seal 160 may be a flexible (e.g. elastomeric) or metal grommet seal having internal and external flanges 162, 164. Seal 160 may take other forms, such as one or more O-rings, and/or one or more face seals.

With reference to FIGS. 2 and 3, the fuel rail 124 may be securely coupled to the outside of valve cover 106 by way of fasteners 170 extending through securement holes 172 in valve cover wall 154. Thus, outlet pipes 134 and fasteners 170 may extend through the same wall of valve cover 106, and wall 154 may be generally planar. Fasteners 170 may include a bolt 174 extend from fuel rail 124, through securement hole 172 in wall 154, and secured thereto by a nut 176. While a bolt 174 and nut 176 configuration is shown in the figures, it is understood that other fasteners 170 and configurations may be used, either temporary or permanent. A seal 176, such as a grommet seal as discussed above, may be located in and/or around securement holes 172 of wall 154 to seal the fasteners 170. It is also contemplated that holes 170 may be threaded blind holes receiving bolts 172. A plurality of fasteners 170 may secure fuel rail 124 to valve cover 106, such as the five fasteners 170 depicted in FIGS. 1 and 2. The fasteners may be located in between a pair of outlet pipes 134.

### INDUSTRIAL APPLICABILITY

The disclosed aspects of the present invention may be used in any engine using a common rail fuel system. For example, the system of the present disclosure may be used in a diesel internal combustion engine with a common fuel rail used to deliver high pressure fuel to fuel injectors of the engine. The fuel injectors may inject the high pressure fuel to combustion chambers for driving the pistons and crankshaft of the engine.

The present disclosure helps to avoid dangerous engine fluids from escaping the engine 100. For example the monolithic fuel rail 124 sealingly extending into a wall of the engine (through the valve box wall 154) provides a fuel rail coupling arrangement that helps to avoid the leaking of dangerous engine fluids, such as fuel and/or oil vapors, from the engine 100. The coupling arrangement helps to limit the number of potential leak paths at the interface of the interior and exterior of the engine 100. The coupling arrangement also helps to limit the number of parts or connections at the interface of the interior and exterior of the engine 100, and thus helps to reduce the complexity of assembly and maintenance in the area. Fewer parts may result in a reduction in cost because fewer parts are needed to be manufactured and there may be a reduction in manufacturing costs. The reduction in parts also means that there is additional space within the assembly that may be used otherwise in the design.

It will be apparent to those skilled in the art that various modifications and variations can be made to the disclosed system without departing from the scope of the disclosure. Other embodiments of the system will be apparent to those skilled in the art from consideration of the specification and practice of the counterweight system disclosed herein. For example, while the present disclosure describes the monolithic fuel rail 124 extending through a valve cover 106 of the engine, it is contemplated that the fuel rail 124 could alternatively extend into other walls of the engine, such into or through a wall of a cylinder head 104. It is intended that the specification and examples be considered as exemplary only, with a true scope of the disclosure being indicated by the following claims and their equivalents.

1. A fuel system for coupling a fuel rail of a common rail fuel system to an internal combustion engine, comprising:
an engine wall having a plurality of openings;
the fuel rail having
a main pipe portion located outside the engine wall, and
a plurality of outlet pipes monolithically formed with the main pipe portion such that the plurality of outlet pipes cannot be disassembled from the main pipe portion, each of the plurality of outlet pipes extending into a corresponding one of the plurality of openings of the engine wall; and
a seal located in sealing engagement with each of the plurality of openings and a corresponding outlet pipe.

2. The fuel system of claim 1, wherein the plurality of outlet pipes of the fuel rail extend generally perpendicular to the main pipe portion.

3. The fuel system of claim 2, wherein the main pipe portion of the fuel rail extends generally parallel a length of the engine.

4. The fuel system of claim 3, wherein the fuel rail is fixedly coupled to the engine wall.

5. The fuel system of claim 4, further including a plurality of fasteners fixedly coupling the fuel rail to the engine wall, each fastener of the plurality of fasteners extending into a corresponding securement opening in the engine wall.

6. The fuel system of claim 5, wherein the wall is generally planar along the length of the fuel rail.

7. The fuel system of claim 1, wherein the engine wall is a wall of a valve cover of the engine.

8. The fuel system of claim 6, wherein the plurality of outlet pipes extend through and beyond a corresponding one of the plurality of openings of the engine wall.

9. The fuel system of claim 1, wherein the seal is one of a grommet seal, O-ring seal, or face seal.

10. The fuel system of claim 1, wherein the each of the plurality of outlet pipes are coupled to fuel lines extending to a corresponding fuel injector.

11. A fuel system for coupling a fuel rail of a common rail fuel system to an internal combustion engine, comprising:
an engine wall having a plurality of openings, the engine wall being a wall of a valve cover of the engine;
the fuel rail having
a main pipe portion located outside the engine wall and extending parallel to the engine wall, and
a plurality of outlet pipes monolithically formed with the main pipe portion such that the plurality of outlet pipes cannot be disassembled from the main pipe portion, each of the plurality of outlet pipes extending into a corresponding one of the plurality of openings of the engine wall;
a seal located in sealing engagement with each of the plurality of openings and a corresponding outlet pipe; and
a plurality of fasteners fixedly coupling the fuel rail to the engine wall, each fastener of the plurality of fasteners extending into a corresponding securement opening in the engine wall.

12. The fuel system of claim 11, wherein the plurality of outlet pipes of the fuel rail extend generally perpendicular to the main pipe portion.

13. The fuel system of claim 12, wherein the main pipe portion of the fuel rail extends generally parallel a length of the engine.

14. The fuel system of claim 13, wherein the wall is generally planar along the length of the fuel rail.

15. (canceled)

16. The fuel system of claim 11, wherein the plurality of outlet pipes extend through and beyond a corresponding one of the plurality of openings of the engine wall.

17. (canceled)

18. The fuel system of claim 11, wherein each of the plurality of outlet pipes are coupled to nonlinear, curved fuel lines extending to a corresponding fuel injector.

19. A system for coupling a fuel rail of a common rail fuel system to an internal combustion engine, comprising:
an engine wall having a plurality of openings;
the fuel rail having
a main pipe portion located outside the engine wall and extending parallel to the engine wall, and
a plurality of outlet pipes monolithically formed with the main pipe portion such that the plurality of outlet pipes cannot be disassembled from the main pipe portion, each of the plurality of outlet pipes extending into, through and beyond a corresponding one of the plurality of openings of the engine wall;
a seal located in sealing engagement with each of the plurality of openings and a corresponding outlet pipe and having internal and external flanges surrounding the outlet pipe, the seal being a grommet seal; and
a plurality of fasteners fixedly coupling the fuel rail to the engine wall, each fastener of the plurality of fasteners extending into a corresponding securement opening in the engine wall.

20. (canceled)

21. The system of claim 1, wherein the engine wall is a wall of a valve cover of the engine and the valve cover forms a common cavity into which each of the plurality of outlet pipes extends.

22. The system of claim 21, wherein each of the plurality of outlet pipes are coupled to nonlinear, curved fuel lines extending to a corresponding fuel injector.

23. The system of claim 1, wherein the seal is located in sealing engagement with each of the plurality of openings and a corresponding outlet pipe has internal and external flanges surrounding the outlet pipe.
